(19) United States
(12) Patent Application Publication
(10) Pub. No.: US 2013/0160758 A1
(43) Pub. Date: Jun. 27, 2013

(54) HEAT-PIPE SOLAR COLLECTOR AND SEALING ASSEMBLY THEREOF

(71) Applicants: Dah-Chyi KUO, Kunshan City (CN); Xue-Hai WANG, Kunshan City (CN); Ling LONG, Kunshan City (CN)

(72) Inventors: Dah-Chyi KUO, Kunshan City (CN); Xue-Hai WANG, Kunshan City (CN); Ling LONG, Kunshan City (CN)

(73) Assignee: Kunshan Jue-Chung Electronics Co., Ltd.

(21) Appl. No.: 13/337,142

(22) Filed: Dec. 25, 2011

(51) Int. Cl. F24J 2/32; F16L 17/06; F16L 19/00

(52) U.S. Cl. 126/635; 277/626; 277/608

(57) ABSTRACT

A heat-pipe solar collector includes a heat-exchanging pipe, a sealing assembly and a heat pipe. The sealing assembly includes a connecting sleeve and a sealing ring. The connecting sleeve includes a pipe post through which the heat pipe is disposed. The sealing ring includes an annular sheath and an annular piece. The annular piece is pressed by the pipe post to abut the heat-exchanging pipe. One end of the heat pipe is disposed in the heat-exchanging pipe via the sealing assembly.

### BACKGROUND OF THE INVENTION

1. Field of the Invention

The present invention relates to a solar collector, and in particular to a heat-pipe solar collector and a sealing assembly thereof.

2. Description of Prior Art

Among the solar devices, solar collector has become a popular device having commercial use and economical benefits. In order to improve the conversion efficiency of the solar energy, heat pipes having good heat conductivity are assembled in the solar collector to serve as heat-conducting elements. Such a heat-pipe solar collector has a good effect.

Please refer to FIGS. 1 and 2, which are a schematic view and a cross-sectional view showing the operation of the heat-pipe solar collector in prior art respectively. As shown in FIG. 1, the heat-pipe solar collector has a sealing assembly 1a. The sealing assembly 1a includes a heat-exchanging pipe 10a, a plurality of branch pipes 20a inserted into the heat-exchanging pipe 10a, and a plurality of heat pipes 30a penetrating the branch pipes 20a respectively. In using the sealing assembly 1a of the solar collector, cold water flows into one end of the heat-exchanging pipe 10a and then takes away the heat contained in the heat pipes 30a. Finally, the water absorbing the heat contained in the heat pipes 30a exits the other end of the heat-exchanging pipe 10a.

In assembling the heat-pipe solar energy, the heat-exchanging pipe 10a is provided with a plurality of penetration holes 11a. Then, the branch pipes 20a are inserted into the penetration holes 11a and welded thereto respectively. Finally, the inner walls of the branch pipes 20a are coated with heat-conducting medium 40a. In this way, the heat pipes 30a can be tightly disposed in the penetration holes 11a.

The assembly of the above-mentioned conventional heat-pipe solar energy 1a is complicated and time-consuming. Further, the water may leak from the solar collector via the welded portions. Nevertheless, the heat pipes 30a are not brought into direct thermal contact with the water in the heat-exchanging pipe 10a. Instead, the heat conduction between the heat pipes 30a and the heat-exchanging pipe 10a is achieved by means of the branch pipes 20a, so that the heat-conducting efficiency is insufficient.

In order to solve the above problems, the present Inventor proposes a novel and reasonable structure based on his expert knowledge and deliberate researches.

### SUMMARY OF THE INVENTION

The present invention is to provide a sealing assembly of a heat-pipe solar collector, which is capable of keeping the tightness between the heat-exchanging pipe and the heat pipe, thereby improving the heat-exchanging effect.

The present invention provides a heat-pipe solar collector, which includes a heat-exchanging pipe, a connecting sleeve, a sealing ring, and at least one heat pipe. The heat-exchanging pipe has an accommodating space. One side surface of the heat-exchanging pipe is provided with a threaded blind hole and at least one through-hole in communication with the accommodating space. The connecting sleeve comprises a pipe post having a penetration hole. The heat pipe is disposed through the penetration hole. The outer surface of the pipe post is provided with a plurality of threads to be threadedly connected into the threaded blind hole. The sealing ring comprises an annular sheath put on the heat pipe and an annular piece extending outwardly from the outer edge of the annular sheath. The annular piece is pressed by the pipe post to abut the through-hole. One end of the heat pipe is disposed through the connecting sleeve and the sealing ring to be accommodated in the heat-exchanging pipe.

The present invention provides a sealing assembly of a heat-pipe solar collector, which is used for connecting a heat-exchanging pipe and a heat pipe. One side surface of the heat-exchanging pipe is provided with a threaded blind hole and a through-hole in the threaded blind hole. The sealing assembly includes a connecting sleeve and a sealing ring. The connecting sleeve comprises a pipe post having a penetration hole. The heat pipe is disposed through the penetration hole. The outer surface of the pipe post is provided with a plurality of threads to be threadedly connected into the threaded blind hole. The sealing ring comprises an annular sheath put on the heat pipe and an annular piece extending outwardly from the outer edge of the annular sheath. The annular sheath is disposed in the penetration hole. The annular piece is pressed by the pipe post to abut the through-hole. One end of the heat pipe is disposed through the connecting sleeve and the sealing ring to be accommodated in the heat-exchanging pipe.

The present invention provides a sealing assembly of a heat-pipe solar collector, wherein the sealing assembly has an O ring and the connecting sleeve abuts the annular piece of the sealing ring and the O ring. By this arrangement, the tightness between the connecting sleeve and the through-hole is kept, and the leakage of the water within the heat-exchanging pipe is prevented.

In comparison with prior art, according to the solar collector of the present invention, the sealing assembly is used to connect the heat pipe into the heat-exchanging pipe and keep the tightness there between. By using the connecting sleeve, the way of connecting the heat pipe to the heat-exchanging pipe is simplified. The sealing ring of the sealing assembly generates a sealing effect and guarantees the tightness, thereby preventing against the leakage of water in the heat-exchanging pipe. Further, in comparison with the indirect heat conduction achieved by the conventional heat pipe, the heat pipe of the present invention is brought into direct thermal contact with the water in the heat-exchanging pipe. Thus, the heat-conducting efficiency and the energy-collecting effect are excellent, so that the present invention demonstrates improved practicability.

### BRIEF DESCRIPTION OF DRAWING

FIG. 1 is a schematic view showing the heat-pipe solar collector in prior art;

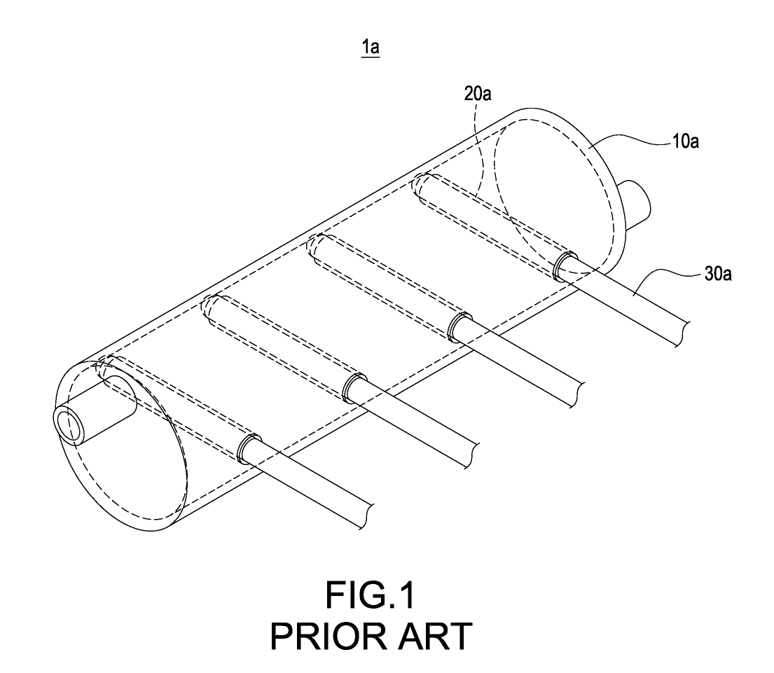

FIG. 2 is a cross-sectional view showing the heat-pipe solar collector in prior art;

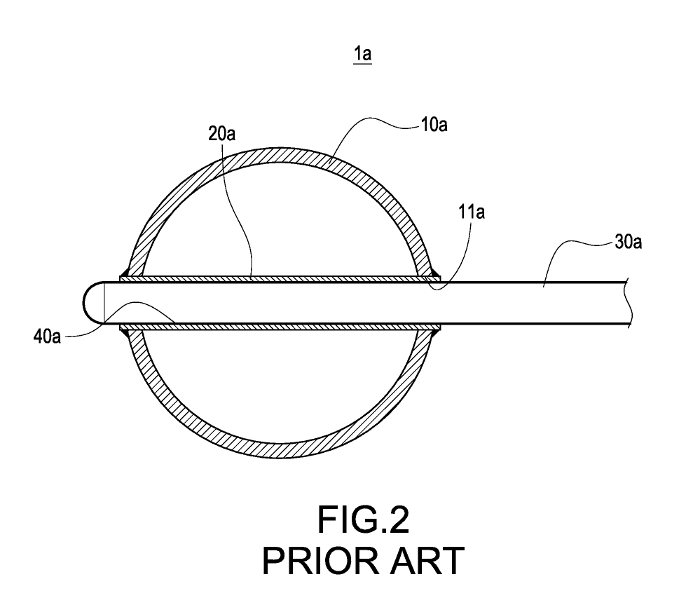

FIG. 3 is a schematic view showing the operation of the heat-pipe solar collector according to the present invention;

FIG. 4 is an exploded perspective view showing the sealing assembly and the heat pipe of the present invention;

FIG. 5 is an assembled view showing the sealing assembly and the heat pipe of the present invention;

FIG. 6 is an assembled perspective view showing the heat-exchanging pipe and the heat pipe of the present invention;

FIG. 7 is a cross-sectional view showing the heat-exchanging pipe and the heat pipe of the present invention;

FIG. 8 is an assembled cross-sectional view showing the heat-pipe solar collector according to the present invention;

FIG. 9 is an assembled view showing the sealing assembly and the heat pipe according to a second embodiment of the present invention; and

FIG. 10 is an assembled cross-sectional view showing the sealing assembly and the heat pipe according to the second embodiment of the present invention.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

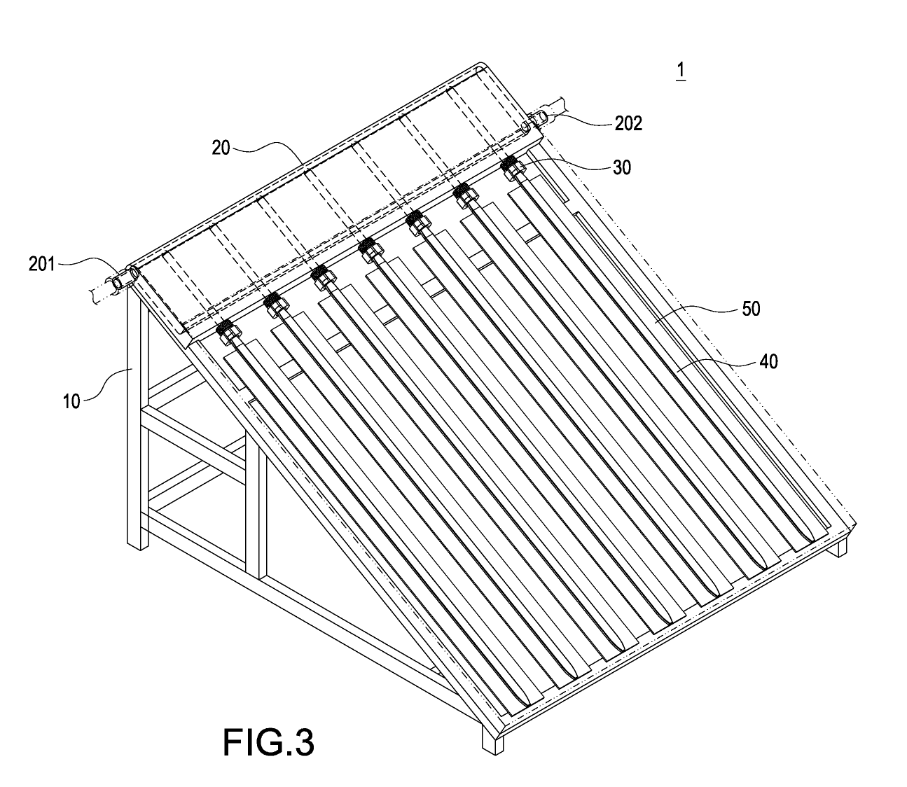

Please refer FIG. 3, which is a schematic view showing the operation of the heat-pipe solar collector according to the present invention. The present invention provides a heat-pipe solar collector 1, which includes a heat-collecting frame 10, a heat-exchanging pipe 20, a sealing assembly 30, at least one heat pipe 40, and at least one heat-collecting plate 50.

In the present embodiment, the heat-collecting frame 10 is a triangular three-dimensional frame, but it is not limited thereto. The heat-exchanging pipe 20 and the heat pipe 40 are fixed to the heat-collecting frame 10. The heat-exchanging pipe 20 is provided at a higher position on the heat-collecting frame 10. The heat pipe 40 is inserted into the heat-collecting plate 50.

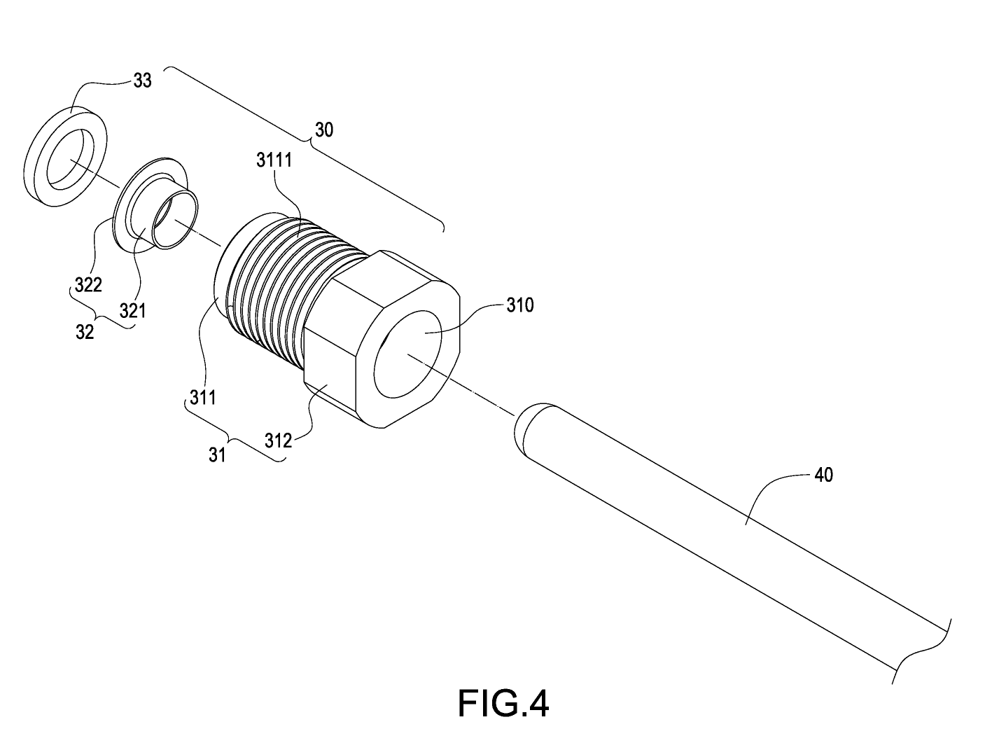

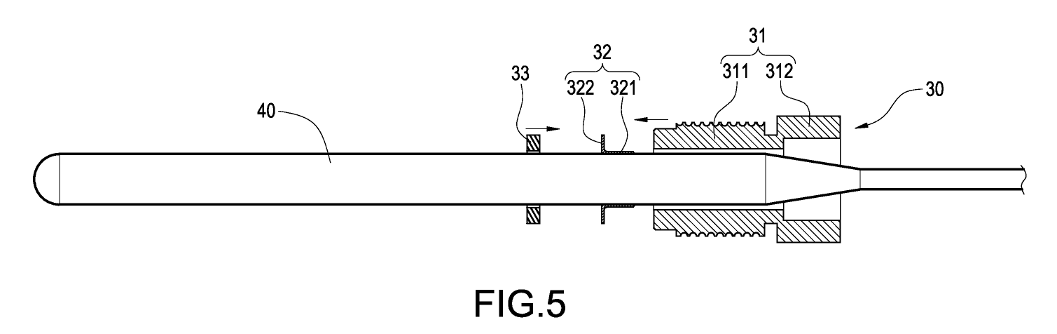

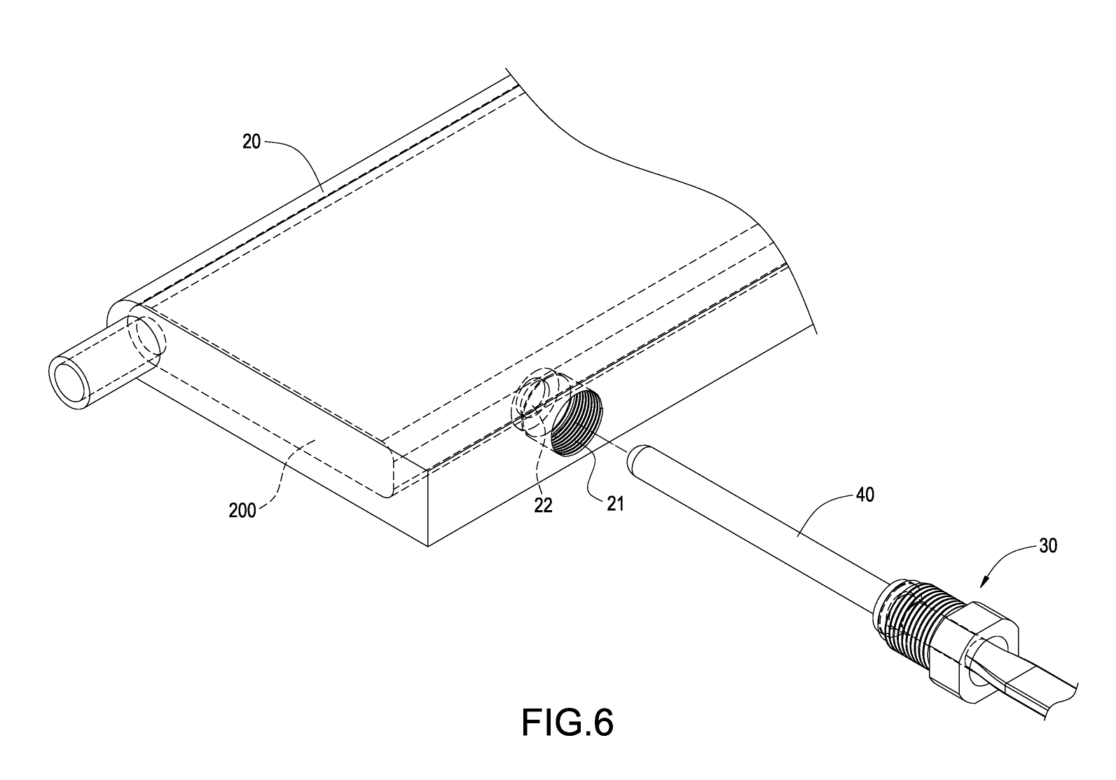

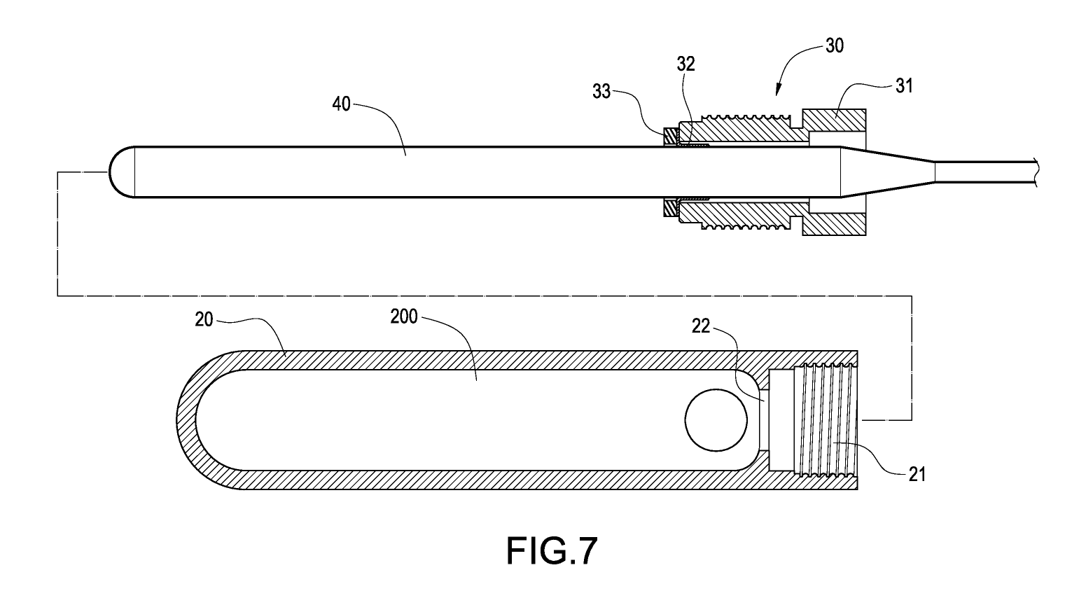

Please refer to FIGS. 4 to 7. FIG. 4 is an exploded perspective view showing the sealing assembly and the heat pipe of the present invention. FIG. 5 is an assembled view showing the sealing assembly and the heat pipe of the present invention. FIG. 6 is an assembled perspective view showing the heat-exchanging pipe and the heat pipe of the present invention. FIG. 7 is a cross-sectional view showing the heat-exchanging pipe and the heat pipe of the present invention. The sealing assembly 30 of the present invention is used to connect the heat-exchanging pipe 20 and the heat pipe 40.

The heat-exchanging pipe 20 has an accommodating space 200. One side surface of the heat-exchanging pipe 20 is provided with a threaded blind hole 21 and at least one through-hole 22 in communication with the accommodating space 200. The inner diameter of the through-hole 22 is slightly larger than that of the outer diameter of the heat pipe 40.

The sealing assembly 30 comprises a connecting sleeve 31, a sealing ring 32 and an O ring 33. The connecting sleeve 31 comprises a pipe post 311 having a penetration hole 310 and a knob 312 connected to the pipe post 311. The penetration hole 310 is provided in the axial center of the pipe post 311 and the knob 312. The inner diameter of the penetration hole 310 is slightly larger than the outer diameter of the heat pipe 40. That is, the heat pip 40 is disposed through the penetration hole 310. The outer surface of the pipe post 311 has a plurality of threads 3111, whereby the pipe post 311 of the connecting sleeve 31 can be threadedly connected into the threaded blind hole 21 of the heat-exchanging pipe 20. In practice, the threaded blind hole 21 is provided with inner threads, and the threads 3111 provided on the pipe post 311 are outer threads.

The sealing ring 32 comprises an annular sheath 321 put on the heat pipe 40 and an annular piece 322 extending outwardly from the outer edge of the annular sheath 321. In the present embodiment, the annular sheath 321 is disposed in the penetration hole 310 of the connecting sleeve 31. That is, the annular sheath 321 is located between the inner surface of the pipe post 311 and the outer surface of the heat pipe 40. The annular piece 322 is pressed by the pipe post 311 to abut the through-hole 22, so that the annular piece 322 can seal the through-hole 22 completely. In practice, the sealing ring 32 can be fixed to the heat pipe 40 by means of a soldering process, a welding process or the like, thereby filling the gap between the annular sheath 321 and the heat pipe 40.

The O ring 33 is put on the heat pipe 40. The O ring 33 is provided on the outside of the sealing ring 32 in such a manner that the O ring 33 is sandwiched between the through-hole 22 of the heat-exchanging pipe 20 and the annular piece 322 of the sealing ring 32. That is, the annular piece 322 abuts against the O ring 33, thereby keeping the tightness between the connecting sleeve 31 and the through-hole 22.

As shown in FIGS. 6 and 7, one end of the heat pipe 40 passes through the sealing assembly 30 (the connecting sleeve 31 and the sealing ring 32) to be disposed in the accommodating space 200 of the heat-exchanging pipe 20.

First, the sealing ring 32 is welded to the heat pipe 40. In assembly, the connecting sleeve 31 and the O ring 33 are put on the heat pipe 40. Then, the knob 312 is rotated to make the heat pipe 40 attached with the sealing assembly 30 to be threadedly inserted into the threaded blind hole 21 until penetrating the through-hole 22. By using the sealing assembly 30, the heat pipe 40 can be tightly connected to the heat-exchanging pipe 20, thereby keeping the tightness therebetween.

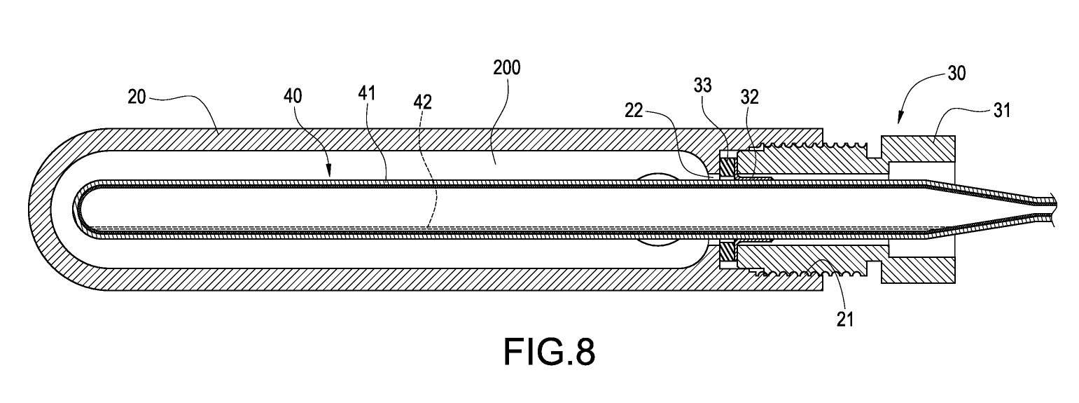

Please refer to FIG. 8, which is an assembled cross-sectional view showing the solar collector of the present invention. The heat pipe 40 is rotatably connected to the heat-exchanging pipe 20 by means of the connecting sleeve 31. The pipe post 311 of the connecting sleeve 31 abuts the annular piece 322 and the O ring 33, thereby keeping the tightness between the connecting sleeve 31 and the through-hole 22 and thus preventing the leakage of water within the heat-exchanging pipe 20. In the present embodiment, the heat pipe 40 comprises a pipe body 41 and the working fluid 42 provided in the pipe body 41. Please also refer to FIG. 3. The heat-exchanging pipe 20 has a water intake port 201 and a water exhaust port 202. Cold water flows into the heat-exchanging pipe 20 from the water intake port 202 and then through the heat pipe 40. The water flowing through the heat pipe 40 carries away the heat contained in the heat pipe 40 and exits the water exhaust port 201. By using the phase change of the working fluid 42 in the heat pipe 40 as a heat-exchange mechanism, the solar collector 1 can achieve a good heat-collecting effect.

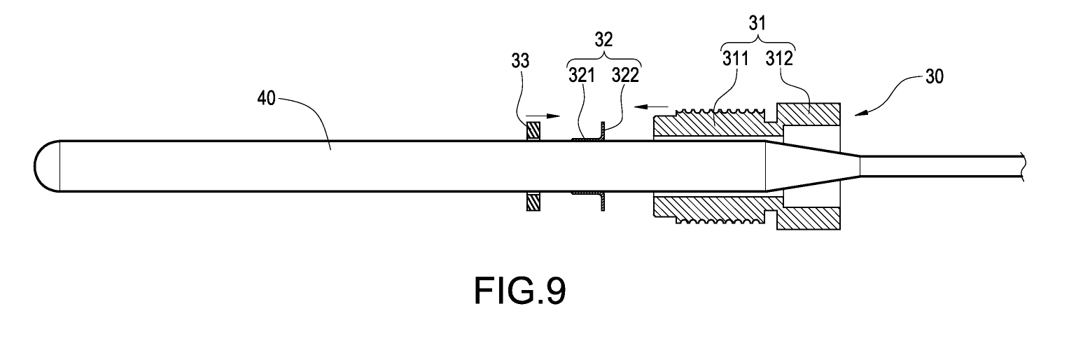

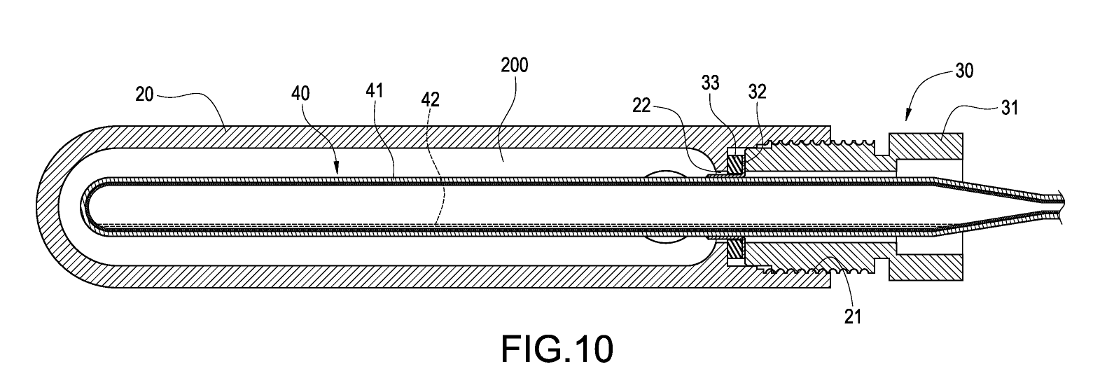

Please refer to FIGS. 9 and 10, which show the sealing assembly and the heat pipe according to the second embodiment of the present invention. The difference between the second embodiment and the first embodiment lies in the orientation of the sealing ring 32. Similarly, the sealing ring 32 comprises an annular sheath 321 put on the heat pipe 40 and an annular piece 322 extending outwardly from the outer edge of the annular sheath 321. In the second embodiment, the annular sheath 321 is provided in a direction opposite to that in the first embodiment. That is, the inner diameter of the O ring 33 is slightly larger than the outer diameter of the heat pipe 40. The annular sheath 321 is disposed inside the O ring 33. The annular piece 322 abuts against the end surface of the pipe post 311.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A sealing assembly of a heat-pipe solar collector, configured for connecting a heat-exchanging pipe and a heat pipe, one side surface of the heat-exchanging pipe being provided with a threaded blind hole and a through-hole in the threaded blind hole, the sealing assembly including:
a connecting sleeve comprising a pipe post having a penetration hole, the heat pipe being disposed through the penetration hole, an outer surface of the pipe post being provided with a plurality of threads to be threadedly connected into the threaded blind hole; and
a sealing ring comprising an annular sheath put on the heat pipe and an annular piece extending outwardly from an outer edge of the annular sheath, the annular sheath being pressed by the pipe post to abut the through-hole;
wherein one end of the heat pipe is disposed through the connecting sleeve and the sealing ring to be accommodated in the heat-exchanging pipe.

2. The sealing assembly of a heat-pipe solar collector according to claim 1, further including an O ring sandwiched between the through-hole and the annular piece.

3. The sealing assembly of a heat-pipe solar collector according to claim 2, wherein the annular sheath is disposed in the penetration hole and located between an inner surface of the pipe post and an outer surface of the heat pipe, and the annular piece abuts the O ring.

4. The sealing assembly of a heat-pipe solar collector according to claim 2, wherein the inner diameter of the O ring is larger than the outer diameter of the heat pipe, the annular sheath is disposed inside the O ring, and the annular piece abuts an end surface of the pipe post.

5. The sealing assembly of a heat-pipe solar collector according to claim 1, wherein the connecting sleeve further comprises a knob connected to the pipe post, and the penetration hole is in communication with the pipe post and the knob.

6. The sealing assembly of a heat-pipe solar collector according to claim 1, wherein the inner diameter of the penetration hole is slightly larger than the outer diameter of the heat pipe.

7. The sealing assembly of a heat-pipe solar collector according to claim 6, wherein the penetration hole is provided in an axial center of the pipe post and the knob.

8. The sealing assembly of a heat-pipe solar collector according to claim 1, wherein the sealing ring is fixed to the heat pipe by a soldering or welding process.

9. A heat-pipe solar collector, including:
a heat-exchanging pipe having an accommodating space, one side surface of the heat-exchanging pipe being provided with a threaded blind hole and at least one through-hole in communication with the accommodating space;
a connecting sleeve comprising a pipe post having a penetration hole, the heat pipe being disposed in the penetration hole, an outer surface of the pipe post being provided with a plurality of threads to be threadedly inserted into the threaded blind hole;
a sealing ring comprising an annular sheath put on the heat pipe and an annular piece extending outwardly from an outer edge of the annular sheath, the annular piece being pressed by the pipe post to abut the through-hole; and
at least one heat pipe, one end of the heat pipe passing through the connecting sleeve and the sealing ring to be disposed in the heat-exchanging pipe.

10. The heat-pipe solar collector according to claim 9, further including a heat-collecting frame, the heat-exchanging pipe and the heat pipe being fixed to the heat-collecting frame.

11. The heat-pipe solar collector according to claim 9, further including at least one heat-collecting plate, the heat pipe being inserted to the heat-collecting plate.

12. The heat-pipe solar collector according to claim 9, further including an O ring, the O ring being sandwiched between the through-hole and the annular piece.

13. The heat-pipe solar collector according to claim 12, wherein the annular sheath is disposed in the through-hole and located between an inner surface of the pipe post and an outer surface of the heat pipe, and the annular piece abuts the O ring.

14. The heat-pipe solar collector according to claim 12, wherein the inner diameter of the O ring is larger than the outer diameter of the heat pipe, the annular sheath is disposed in the O ring, and the annular piece abuts an end surface of the pipe post.

15. The heat-pipe solar collector according to claim 9, wherein the connecting sleeve further comprising a knob connected to the pipe post, and the penetration hole is in communication with the pipe post and the knob.

16. The heat-pipe solar collector according to claim 9, wherein the inner diameter of the through-hole is slightly larger than the outer diameter of the heat pipe.

17. The heat-pipe solar collector according to claim 9, wherein the inner diameter of the penetration hole is slightly larger than the outer diameter of the heat pipe.

18. The heat-pipe solar collector according to claim 9, wherein the sealing ring is fixed to the heat pipe by a soldering or welding process.
